(19) United States
(12) Patent Application Publication
(10) Pub. No.: US 2006/0080375 A1
(43) Pub. Date: Apr. 13, 2006

(54) Method and apparatus for inverse discrete cosine transform implementation

(76) Inventor: Kun-Bin Lee, Hsin-Chu City (TW)

Correspondence Address: HOFFMAN WARNICK & D'ALESSANDRO, LLC, 75 STATE STREET, 14TH FL, ALBANY, NY, 12207, US

(21) Appl. No.: 10/962,647

(22) Filed: Oct. 12, 2004

(51) Int. Cl. G06F 17/14

(52) U.S. Cl. 708/402

(57) ABSTRACT

A data processing apparatus and the same method utilize a first and a second IDCT circuits, a transpose memory, and a controller to perform a first and a second 1-D IDCT procedures. The apparatus performs IDCT procedure on a plurality of incoming data with zero and/or non-zero information. The apparatus further comprises at least one tag table for keeping records of corresponding zero and non-zero information associated with the incoming data. The controller records the corresponding zero and/or non-zero information in the tag table so as to reduce the data processing time of the first and/or the second IDCT circuit. The controller can also direct the first IDCT temporary data both to the first and the second IDCT circuits for concurrently performing the second 1-D IDCT procedure. An associated architecture for the transpose memory and the associated data-writing and/or data-reading sequences for accessing the transpose memory are also disclosed in order to balance the IDCT work load between the first and the second 1-D IDCT circuits during the second 1-D IDCT procedure.

### BACKGROUND OF THE INVENTION

1. Field of the Invention

The present invention relates to a method and an apparatus for implementing inverse discrete cosine transform (IDCT). More particularly, the present invention relates to a method and an apparatus for implementing IDCT with an aid of a tag table and an improved transpose memory to short IDCT processing time.

2. Description of the Prior Art

Traditionally, an IDCT method and apparatus perform IDCT process on every incoming discrete cosine transform data (or also known as DCT data, DCT coefficient), without checking the content therein. Therefore, even though there are some meaningful contents in the incoming DCT coefficients, no special treatment is made in a traditional IDCT process. Some proposals and amendments have been made to give special treatment on some identified special DCT coefficients, so that some desired effects are gained, such as to reduce the total amount of DCT/IDCT data calculation. Such proposals can be found in the actual product relating to JPEG or MPEG decoding. For the purpose of reducing data calculation, many fast algorithms have been proposed to reduce the amount of data calculation on a DCT coefficient. However, even though the amount of data calculation might be reduced within the calculation process of the to-be-processed DCT coefficient, these proposed algorithms still need to process every incoming DCT coefficient.

For example, in U.S. Pat. No. 6,167,092, it is proposed that the position of the last non-zero coefficient is utilized to decide which sets of different length 1-D IDCT are to be processed. In U.S. Pat. No. 5,883,823, all the DCT coefficients are categorized into two groups: the first group comprises low-frequency 4×4 DCT coefficients, and the second group comprises the other DCT coefficients. Then the regional IDCT algorithm is performed on all the DCT coefficients in the first group, whether they are zero or non-zero. The traditional IDCT algorithm is performed on all the other DCT coefficients in the second group. In these two patents, zero and non-zero DCT coefficients are not treated differently; therefore these patents can benefit no advantage due to this valuable distinguishing.

In U.S. Pat. No. 5,576,958, a judgment is imposed on the input port of 1-D IDCT to see whether the incoming DCT coefficient is zero or non-zero. If it is zero, the normally followed multiplication calculation associated with this coefficient can then be omitted. However, this algorithm judges merely one coefficient in one specific time unit. Though the total amount of data calculation can then be reduced, the time spent in the multiplication calculation pertaining to one non-zero DCT coefficient is not reduced. Directly performing 2-D IDCT process, instead of performing 1-D IDCT process twice separately, U.S. Pat. No. 5,636,152 performs IDCT process only on non-zero coefficients. In this algorithm, it can save both the time spent on zero coefficient calculation and the time spent judging whether the coefficient is zero or non-zero. However, this algorithm benefits at the expense of employing complex circuit structure, such as N×N accumulators and one direct 2-D IDCT circuit, and therefore is deemed to be not cost-effective. U.S. Pat. No. 6,421,695 is similar in one aspect with U.S. Pat. No. 5,636,152: it performs IDCT process only on non-zero coefficients. However, it also differs in another aspect with U.S. Pat. No. 5,636,152: it is based on 1-D IDCT structure. As for the input data order in U.S. Pat. No. 6,421,695, there are two kinds: one is zigzag order, and the other is inverse zigzag order. To put the input data in the first zigzag order, the buffer in the input port can be saved. However, the required transpose memory would be very complex. To put the input data in the second inverse zigzag order, the inverse zigzag scanned non-zero input data is first stored in the buffer of the input port. Then, only the non-zero coefficients are calculated according to the position information of the stored input data in the non-zero feeding unit. To employ this algorithm, a large memory would be required to store the position information. Besides, there are few non-zero coefficients while performing the first 1-D IDCT process, whereas there are many more non-zero coefficients while performing the second 1-D DCT process. Because of the aforementioned reasons, the efficiency of this algorithm would largely depend on the volume capacity of the transpose memory and the processing capacity of the second 1-ID DCT process. Besides, once the capacity of the transpose memory is enlarged, the corresponding memory structure would inevitably become very complex and very difficult for controlling purpose.

Therefore, there is a need to provide a method and corresponding apparatus for solving the above-mentioned problems, especially to reduce the data processing time in IDCT.

### SUMMARY OF THE INVENTION

One objective of the present invention is to provide a fast IDCT implementation method and an apparatus, which can shorten the processing time by reducing the amount of data or coefficients that need to be processed or calculated with the aid of a simple tag table. Another objective of the present invention is to provide an IDCT implementation method and an apparatus which can accelerate the processing speed of the second 1-D IDCT calculation while performing the complete 2-D IDCT process.

Another objective of the present invention is to provide a fast IDCT implementation method and an apparatus, which can balance the workload of the second 1-D IDCT calculation between a first and a second 1-D IDCT circuits.

Another objective of the present invention is to provide a data access sequence which may includes a data-writing sequence and/or a data-reading sequence for accessing a transpose memory in a fast IDCT implementation to assist the load balance between the first and the second 1-D IDCT circuit.

The present invention discloses several embodiments to teach how to shorten the processing time in an IDCT implementation, which especially performs the 1-D IDCT process twice separately. For example, according to one embodiment of the present invention, the data processing apparatus includes a multiplexer, a first IDCT circuit, a transpose memory, a second IDCT circuit, a tag table memory, and a controller. A first tag table and/or a second tag table are stored in the tag table memory. The controller further includes an address generator to control the operation of the first IDCT circuit, the transpose memory, and the second IDCT circuit. The first tag table can be employed, in part, to assist and to achieve the goal of blocking the zero DCT data from entering the first IDCT circuit. Due to the general fact that there are only few non-zero DCT data, but a lot of zero DCT data in an incoming DCT block, the IDCT computation amount needed in the first IDCT circuit is largely reduced by blocking those zero DCT data from entering the first IDCT circuit.

For example, according to another embodiment of the present invention, the second tag table is employed and referenced in the data processing apparatus, so that the second IDCT circuit only needs to read out the non-zero first IDCT temporary data, rather than all the first IDCT temporary data stored the transpose memory. In this way, the access time of the transpose memory is largely reduced because only non-zero first IDCT temporary data are accessed.

There are also other embodiments proposed to achieve the goal of further expediting the IDCT data processing, thus shortening the data processing time. For example, according to another embodiment of the present invention, more than one second IDCT circuits could be employed for sharing the data processing load while performing second 1-D IDCT calculation. For example, according to another embodiment of the present invention, the second IDCT circuit can be an N-pixel 1-D IDCT circuit or an N-digit 1-D IDCT circuit in order to process more data in a given time period.

A more efficient architecture for the transpose memory is also disclosed. For example, according to another embodiment of the present invention, the data-writing and/or data-reading sequence for accessing the transpose memory in the data processing apparatus are also disclosed in order to balance the IDCT work load between the first and the second 1-D IDCT circuits.

The advantage and spirit of the invention may be understood by the following recitations together with the appended drawings.

### BRIEF DESCRIPTION OF THE APPENDED DRAWINGS

FIG. 1 shows the data flow for the generation of the DCT data associated with the present invention.

FIG. 2 shows the block diagram of the data processing apparatus according to the present invention.

FIG. 3A shows the DCT block with a plurality of DCT data.

FIG. 3B shows the first tag table with a plurality of tag values.

FIG. 4A shows the data block with a plurality of first IDCT temporary data.

FIG. 4B shows the second tag table with a plurality of tag values.

FIG. 5 shows the simplified block diagram of the data processing apparatus according to the present invention in FIG. 2.

FIG. 6 shows the simplified and modified block diagram of the data processing apparatus according to the present invention in FIG. 2 employing more second IDCT circuits.

FIG. 7 shows the simplified and modified block diagram of the data processing apparatus according to the present invention in FIG. 2 employing N-pixel 1-D IDCT circuit as the second IDCT circuit.

FIG. 8 shows the simplified and modified block diagram of the data processing apparatus according to the present invention in FIG. 2 employing N-digit 1-D IDCT circuit as the second IDCT circuit.

FIG. 9A shows the clock cycle and the related operations during the first 1-D IDCT procedure according to the present invention.

FIG. 9B shows the clock cycle and the related operation during the second 1-D IDCT procedure according to the present invention.

FIG. 10 shows the diagram of a single-bank, single-port, two words/entry transpose memory.

FIG. 11 shows the diagram of a multi-bank, single-port, one word/entry transpose memory.

### DETAILED DESCRIPTION OF THE INVENTION

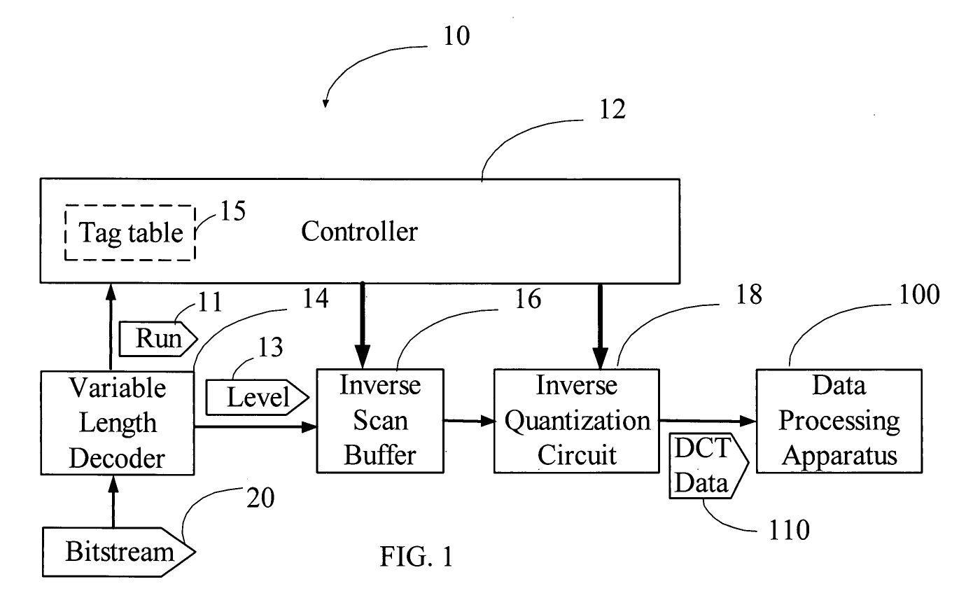

FIG. 1 shows the data flow for the generation of the DCT data 110 associated with the present invention. Typically, the inputs for the data processing apparatus 100 according to the present invention are DCT data 110 generated from a prior-stage system 10. The main function of the prior-stage system 10 is to receive and process the bitstream which contains the data to be processed in the following IDCT procedure relating to the present invention. The prior-stage system 10 typically includes a controller 12, a variable length decoder 14, an inverse scan buffer 16, and an inverse quantization circuit 18. The variable length decoder 14 receives the bitstream 20, decodes the data therein and then generates a run information 11 and a level information 13. The run information 11 and the level information 13 are in fact well understood by persons skilled in the DCT/IDCT art. The aforementioned information is not critical to the present invention, and is therefore not explained here. However, it is worth noting that in order to better facilitate the data processing apparatus 100, the run information 11 can be utilized to generate a tag table 15 to pre-record the related zero/non-zero information associated with the data decoded from the bitstream 20. According to the present invention, tag table 15 is preferred to, though not necessarily, be created in this stage and pre-record those related zero/non-zero information for further usage in the data processing apparatus 100. The explanation associated with the tag table will be detailed in the later paragraph. In the prior arts, the inverse scan buffer 16 would store the level information 13 and perform zero padding under the control of the controller 12. In the present invention, zero padding is not required to be performed due to the use of the tag table. The inverse quantization circuit 18, also under the control of the controller 12, then receives the content stored in the inverse scan buffer 16 for performing inverse quantization procedure. Along the data flow, the DCT data 110 are hereby generated. It should be noted that in some implementations, the inverse quantization circuit 18 is placed before the inverse scan buffer 16 to first perform the inverse quantization procedure and then the inverse scan procedure. Such variations of the aforementioned implementations do not depart from the spirit of the present invention and are well within the scope of the present invention.

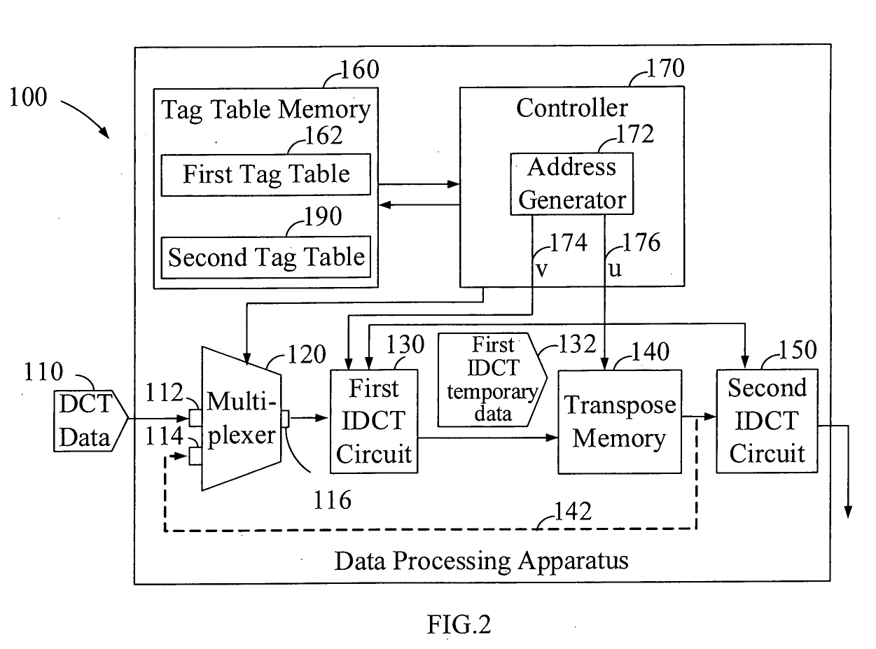

FIG. 2 shows the block diagram of the data processing apparatus 100 according to the present invention. In FIG. 2, it is shown that a data processing apparatus 100 according to the present invention mainly performs IDCT procedure on the incoming DCT data 110. The data processing apparatus is usually coupled to the inverse quantization circuit 18 in the prior-stage system 10. The incoming DCT data 110 are usually DCT data which have finished their due inverse quantization procedure in the inverse quantization circuit 18 (and/or the inverse scan procedure in the inverse scan circuit 16) as briefly explained in FIG. 1. Therefore, those incoming data can also be properly described as, but not necessarily limited to, inverse-quantized DCT data 110. The data processing apparatus 100 according to the preferred embodiment of the present invention includes a multiplexer 120, a first IDCT circuit 130, a transpose memory 140, a second IDCT circuit 150, a tag table memory 160, and a controller 170. A first tag table 162 and/or a second tag table 192 are stored in the tag table memory 160. The controller 170 further includes an address generator 172. Those components will be further explained in the following paragraphs.

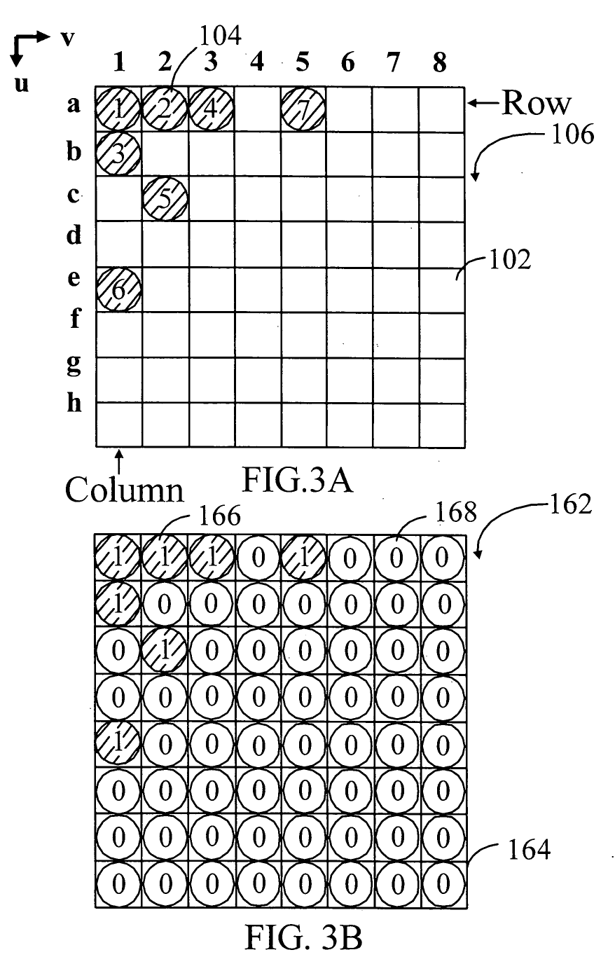

FIG. 3A shows the DCT block 106 with a plurality of DCT datums 102, 104. The data processing apparatus 100 receives the inverse-quantized DCT data 110 coming from the inverse quantization circuit 18 in the prior-stage system 10. The inverse-quantized DCT data 110 are arranged in corresponding DCT blocks. Each DCT block 106 has a plurality of rows and columns of DCT data 102, 104, etc. The inverse-quantized DCT datums 110 can be characterized into at least two distinct categories, for example: zero DCT datum 102 and non-zero DCT datum 104. In FIG. 3A, for illustration purpose, the zero DCT datum 102 is shown and expressed as the empty entry without any label. Here for another illustration purpose, the values of the non-zero DCT datums are given from 1 to 7. In a real case, it is not necessary to be in this way, and the non-zero DCT datums can range from −(2ⁿ)˜2ⁿ−1 except zero, n represents a non-negative integer number.

FIG. 3B shows the first tag table 162 with a plurality of tag values. As shown in FIG. 3B, the first tag table 162 is stored in the tag table memory 160 and keeps records of corresponding category information associated with the incoming data. The first tag table 162 also has a plurality of entries 164 to form corresponding rows and columns for recording zero information 168 and non-zero information 166 associated with the DCT data 110. The number of the entries in the first tag table 162 is usually, but not necessarily, the same as the number of DCT data 110 in one DCT block. The zero information 168 of the DCT data 110 is labeled as a first state in a corresponding entry in the first tag table 162. The non-zero information 166 of the DCT data 110 is labeled as a second state in a corresponding entry in the first tag table 162. The first/second states are utilized just for classification and/or distinguishing purpose. For example, as shown in FIG. 3B, the zero information 168 of the DCT data 110 can be labeled as one digital bit 0 in the corresponding entry in the first tag table 162, whereas the non-zero information 166 of the DCT data 110 is labeled as one digital bit 1 in a corresponding entry in the first tag table 162. However, the tag value associated with the zero/non-zero information is not necessarily assigned in this way. For example, the zero information of the DCT data 110 can also be labeled as one digital bit 1 in the corresponding entry in the first tag table 162, and the non-zero information of the DCT data 110 is labeled as one digital bit 0 in a corresponding entry in the first tag table 162. As long as the zero/non-zero DCT data can be clearly represented in the first tag table 162 for distinguishing purpose, the actual representation or implementation for the corresponding tag value is not so critical. It is worth noting that the tag table 15 generated in the prior-stage system 10 can just be generated as aforementioned. Therefore, the tag table 15 can readily be copied from the prior-stage system 10 and serve as the first tag table 162 in the data processing apparatus 100. In this way, the tag table 15 in the prior-stage system 10 can be directly introduced and utilized by the data processing apparatus 100 with no need to generate the first tag table 162 again.

Back to FIG. 2, the data processing apparatus 100 receives the inverse-quantized DCT data 110 coming from the inverse quantization circuit 18 coupled to the data processing apparatus 100. The multiplexer 120 selectively receives inputs from the incoming DCT data 110 and data from the data line 142 connecting to the transpose memory 140. The first IDCT circuit 130 then performs a first 1-D IDCT procedure on those data, for example the incoming DCT data 110 from the multiplexer 120, and generates corresponding first IDCT temporary data 132. The generated first IDCT temporary data 132 are temporarily stored in the transpose memory 140. The second IDCT circuit 150 would perform a second 1-D IDCT procedure on the first IDCT temporary data 132 from the transpose memory 140. The controller 170 then controls the first 1-D IDCT procedure in the first circuit 130 and the second 1-D IDCT procedure in the second circuit 150. The controller 170 also controls the data access, including data writing, data storing, and data reading etc., of the IDCT temporary data in the transpose memory 140.

Specifically, the multiplexer 120 has two input ports 112, 114, which are coupled to the inverse quantization circuit 18 and the transpose memory 140 respectively. The multiplexer 120 has one output port 116 coupled to the first IDCT circuit 130. The input port 112 of the multiplexer 120 receives inputs of the incoming DCT data 110 from the inverse quantization circuit 18. The input port 114 of the multiplexer 120 receives inputs of data from the data line 142 connecting to the transpose memory 140. The output port 116 of the multiplexer 120 then outputs either the incoming DCT data 110 or the data from the data line 142 to the first IDCT circuit 130. The data from the data line 142 will be explained in more detail in the furtherance.

After referencing the zero information 168 and/or non-zero information 166 associated with the incoming DCT data 110 recorded in the first tag table 162, the controller 170 can readily analyze those data 110 to identify whether the current incoming DCT datum is zero or not. When the current incoming datum is identified to be a zero DCT datum after the first tag table 162 is referenced, the identified-to-be-zero datum is blocked from entering the first IDCT circuit 130 so as to reduce the total amount and time of calculation in the first IDCT circuit 130. That means, only the identified-to-be-non-zero datum is allowed to enter the first IDCT circuit 130 for further first 1-D IDCT calculation procedure. The IDCT calculation procedure is well-known for the persons skilled in the art, and will not be detailed and explained here.

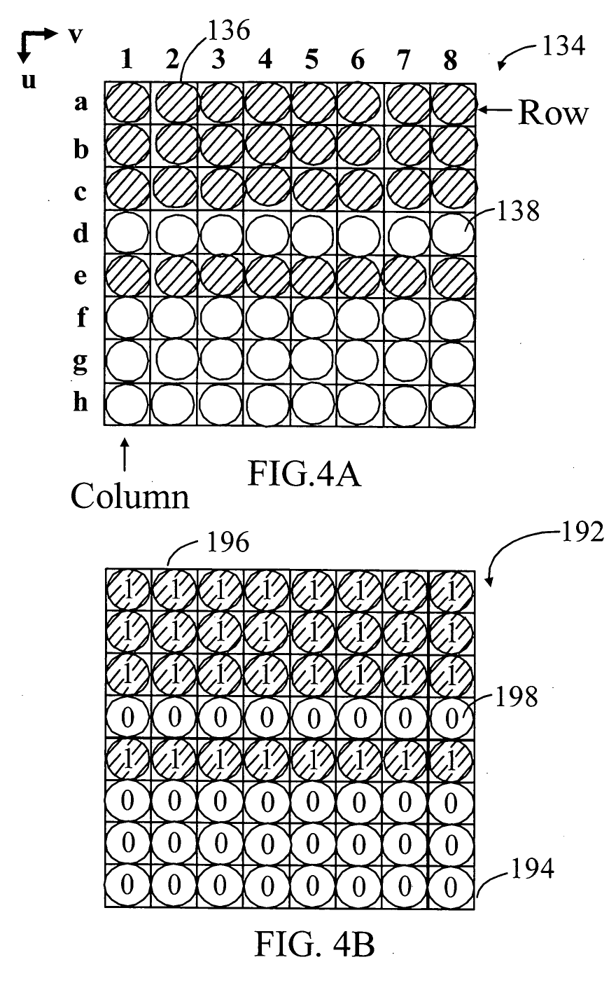

FIG. 4A shows the data block 134 with a plurality of the first IDCT temporary data 132. FIG. 4B shows the second tag table 192 with a plurality of tag values 196, and 198. The first IDCT circuit 130 performs the first 1-D IDCT calculation procedure on the DCT data 110, and generates the corresponding first IDCT temporary data 132 as shown in FIG. 4A. In one embodiment of the present invention, after the corresponding first IDCT temporary data 132 are generated by the first IDCT circuit 130, the corresponding zero information 198 and/or non-zero information 196 associated with the generated first IDCT temporary data 132 are recorded in the second tag table 192. The second tag table 192 also has a plurality of entries 194 to form corresponding rows and columns for recording zero information 198 and non-zero information 196 associated with those generated first IDCT temporary data 132. There are two ways to generate the second tag table 192: one is simpler and the other is more complicated. The simpler way only checks in which row the first 1-D IDCT procedure actually takes place, and fills the non-zero information 196 in all the entries in this identified row. The more complicated way, however, further checks in which entry in each row the first 1-D IDCT procedure actually generates a corresponding non-zero result, and fills the non-zero information 196 in that identified entry of the identified row.

Instead of reading out all the first IDCT temporary data 132 from the transpose memory, during the second 1-D IDCT procedure, only the non-zero first IDCT temporary data 136 are read out from the transpose memory 140 according the corresponding zero information 198 and/or non-zero information 196 recorded in the second tag table 192. The non-zero first IDCT temporary data 136 read out from the transpose memory 140 are then processed according to the second 1-D IDCT procedure. The second 1-D IDCT procedure can be performed only in the second IDCT circuit 150, or preferred both in the first IDCT circuit 130 and in the second IDCT circuit 150. Due to the zero information 198 and/or non-zero information 196 pre-recorded in the second tag table 192, the non-zero first IDCT temporary data 136 can be correctly read out and processed. In this way, the access time of the transpose memory 140 is largely reduced because no zero first IDCT temporary data 138 need to be written in and read out from the transpose memory 140.

In another embodiment of the present invention, after the corresponding first IDCT temporary data 132 are generated by the first IDCT circuit 130, the corresponding zero information 198 and/or non-zero information 196 associated with the generated first IDCT temporary data 132 are not recorded in the separated second tag table 192, but are updated in the same first tag table 162. Similar to the aforementioned paragraph, there are also two ways to update the first tag table 162: one is simpler and the other is more complicated. The simpler way only checks in which row the first 1-D IDCT procedure actually takes place, and fills the non-zero information 196 in all the entries in this identified row. The more complicated way, however, further checks in which entry in each row the first 1-D IDCT procedure actually generates a corresponding non-zero result, and fills the non-zero information 196 in that identified entry of the identified row.

According to the zero information 198 and/or non-zero information 196 updated in the first tag table 162, during the second 1-D IDCT procedure, only the non-zero first IDCT temporary data 136 are read out from the transpose memory 140. That means, it doesn't have to read out all the first IDCT temporary data 132 from the transpose memory 140. The non-zero first IDCT temporary data 136 can also be correctly read out and processed for performing the second 1-D IDCT procedure. The second 1-D IDCT procedure can be performed only in the second IDCT circuit 150, or preferred both in the first IDCT circuit 130 and in the second IDCT circuit 150. In this way, the access time of the transpose memory 140 is largely reduced because no zero first IDCT temporary data 138 need to be written in and read out from the transpose memory 140. That is, because the tag values of the zero information 168 and/or non-zero information 166 are useless after the first 1D IDCT procedure is completed, they can be replaced or updated by the zero information 198 and/or non-zero information 196 using the same memory space of the first tag table 162. This will further reduce the memory capacity requirement and save some memory space. The first IDCT temporary data 132 are generated in the first IDCT circuit 130 by performing the 1-D IDCT procedure, and then are written into corresponding entries in the transpose memory 140. These are all under the controlling of the controller 170. The controller 170 comprises an address generator 172 for issuing a row address signal (u) and a column address signal (v). In a preferred embodiment, during the first 1D IDCT procedure, the row address signal (u) and the column address signal (v) are both required to be issued from the controller 170 so as to facilitate the first 1IDCT procedure in the first IDCT circuit 130. However, during the second 1IDCT procedure, only the row address signal (u) is required to be issued from the controller 170 so as to facilitate the second 1IDCT procedure in the first IDCT circuit 130 and/or the second IDCT circuit 150. Because the first 1IDCT procedure is usually first performed row by row, it is unpredictable as to which row and which column the non-zero DCT data or coefficient 104 would occur. Therefore both the row address signal (u) and the column address signal (v) are required in the first IDCT circuit 130. However, when the second 1D IDCT procedure is performed column by column, almost every column contains some first IDCT temporary data 132 that need to be processed. Therefore, no specific column address signal (v) must be provided by the address generator 172 of the controller 170 before the first IDCT circuit 130 and/or the second IDCT circuit 150 can correctly perform the second 1IDCT procedure.

The transpose memory 140 can take many forms. For example, the transpose memory 140 can be a single-port memory. Because of its “single-port” character, the transpose memory 140 allows either reading data therefrom or writing data thereto, but not both, at a particular time. In comparison with the commonly-utilized multi-port memory, the silicon memory size for the single-port memory in the present invention can be greatly reduced. After the first IDCT circuit 130 generates the first IDCT temporary data 132, the first IDCT temporary data 132 are written into the corresponding entries in the transpose memory 140 under the control of the row address signal (u) from the address generator 172. The column address signal (v) from the address generator 172 is not necessarily required by the transpose memory 140 due to the substantial reason stated in the previous paragraph. In a preferred embodiment of the present invention, the entries in the transpose memory 140 are only half of the entries in one DCT block. Every entry in the transpose memory 140 stores two first IDCT temporary data. The two first IDCT temporary data stored in the same entry are read out in the same clock cycle from the transpose memory 140 and are sent to the first IDCT circuit 130 and the second IDCT circuit 150 respectively.

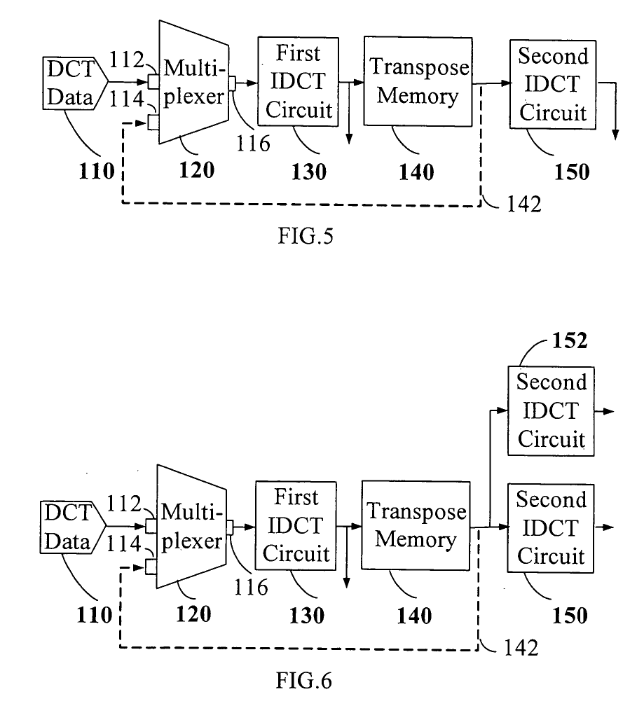

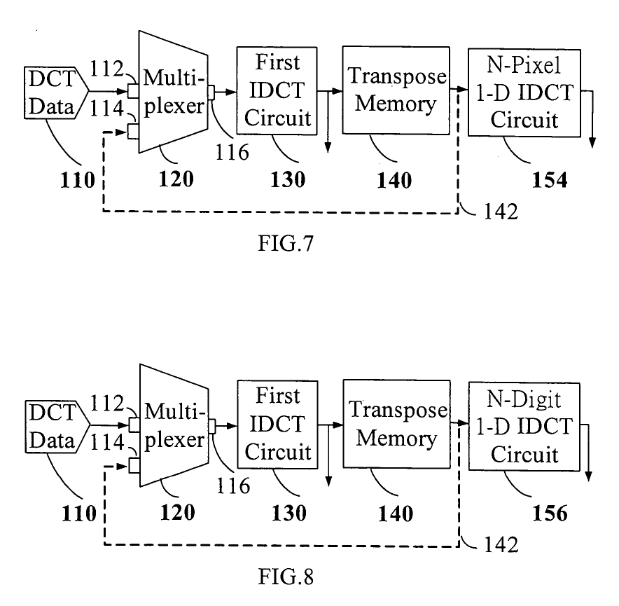

To balance the data processing load, after the first IDCT temporary data 132 are read out from the transpose memory 140, they are directed both to the first circuit 130 and the second IDCT circuit 150. This is to utilize the idle capacity of the first circuit 130 when the second 1-D IDCT procedure is performed. In this way, the second 1-D IDCT procedure for further processing the first IDCT temporary data 132 are concurrently performed in the first circuit 130 and the second IDCT circuit 150. Therefore, half of the first IDCT temporary data 132 are directed to the input port 114 of the multiplexer 120 for performing the second 1-D IDCT procedure. By performing the second 1-D IDCT procedure in a way that balances the IDCT work load both in the first IDCT circuit 130 and in the second IDCT circuit 150, the goal of shortening the processing time in the second IDCT procedure is thereby achieved. In order to further expedite the processing time, there are some proposals to achieve this goal by referencing FIG. 5 to FIG. 8. FIG. 5 shows the simplified block diagram of the data processing apparatus according to the present invention in FIG. 2. FIG. 6 shows the simplified and modified block diagram of the data processing apparatus according to the present invention in FIG. 2 employing more second IDCT circuits. FIG. 7 shows the simplified and modified block diagram of the data processing apparatus according to the present invention in FIG. 2 employing N-pixel 1-D IDCT circuit as the second IDCT circuit. FIG. 8 shows the simplified and modified block diagram of the data processing apparatus according to the present invention in FIG. 2 employing N-digit 1-D IDCT circuit as the second IDCT circuit. As shown in FIG. 5, for clear illustration and referencing purpose, the data processing apparatus 100 in FIG. 2 are simplified in FIG. 5. In order to further expedite the processing time, there are some modifications done based on the simplified FIG. 5 to achieve this goal. For example as shown in FIG. 6, the data processing apparatus 100 can include more than one second IDCT circuits 150, 152, etc. coupled to the transpose memory 140. In this way, more second IDCT circuits 150, 152 can help to share the data processing load while the second 1-D IDCT procedure is performed. There are other options, for example as shown in FIG. 7, the second IDCT circuit can be an N-pixel 1-D IDCT circuit 154. For example as shown in FIG. 8, the second IDCT circuit can be an N-digit 1-D IDCT circuit 156. The detailed implementation of an N-pixel 1-D IDCT circuit or an N-digit 1-D IDCT circuit can be found in currently available disclosure. For example, the detailed description relating to the N-digit 1-D IDCT circuit can be referenced from: S. A. White, “Applications of distributed arithmetic to digital signal processing: a tutorial review,” IEEE Signal Processing Magazine, Vol. 6, issue 3, pp. 4-19, July 1989.

It is worth mentioning that in order further to achieve the goal of shortening the processing time in the second IDCT circuit 150, the second 1-D IDCT procedure can be performed in the way that balances the IDCT work load both in the first IDCT circuit 130 and in the second IDCT circuit 150, 152, 154, 156. FIG. 5 to FIG. 8 demonstrate an embodiment when the first IDCT circuit 130 is optionally included and involved to help the data processing in the second 1-D IDCT procedure. In such an embodiment, the dash lines in FIG. 5˜FIG. 8 mean that part of the first IDCT temporary data 132 stored in the transpose memory 140 are directed to the input port 114 of the multiplexer 120 via the data line 142 for performing the second 1-D IDCT procedure. It is also worth mentioning again that the aforementioned solution of including the first IDCT circuit 130 for expediting data processing in the second 1-D IDCT procedure is merely optional. The first tag table 162 and/or the second tag table 190 explained in FIG. 2 can stand alone in achieving the purpose of shortening the processing time of the data processing apparatus 100.

Since the first and the second IDCT procedures are accelerating by adopting the aforementioned proposals, the transpose memory 140 also needs suitable adjustment in order to effectively expedite the whole 2-D IDCT procedure.

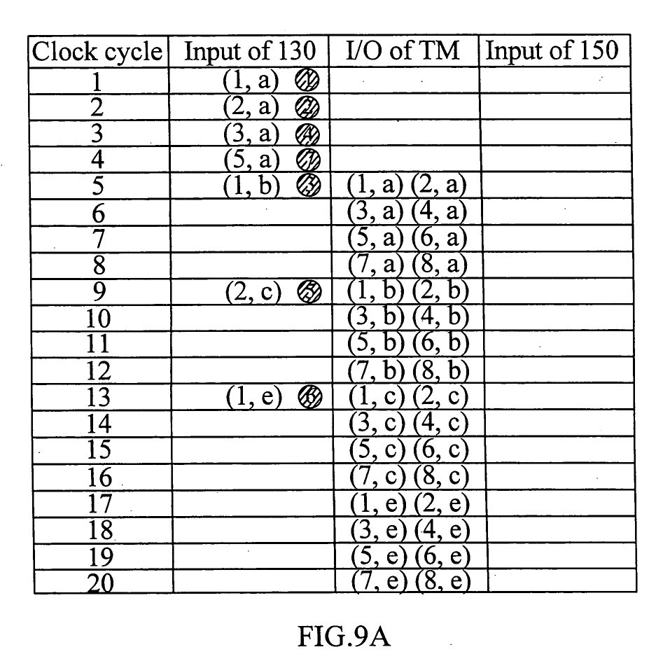

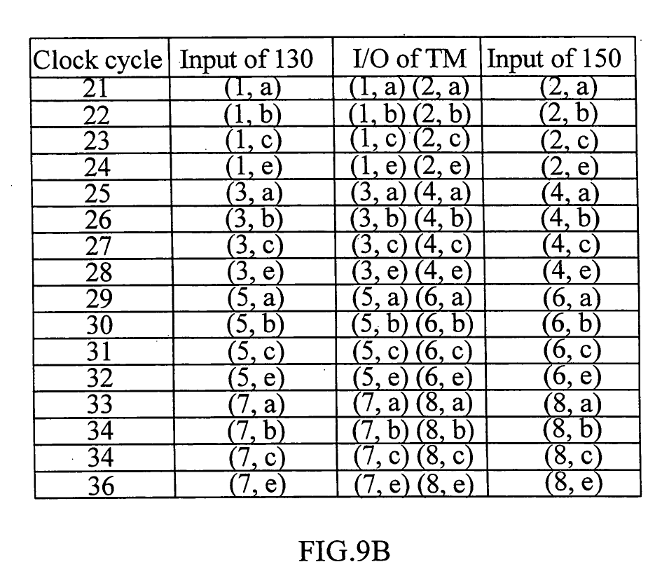

FIG. 9A shows the clock cycle and the related operation during the first 1-D IDCT procedure according to the present invention. As shown in FIG. 9A and FIG. 3A, during clock cycles 14, the non-zero DCT data (1a), (2a), (3a), (5a) in the first row of the DCT block 106 shown in FIG. 3A are inputted to the first circuit 130. The corresponding first IDCT temporary data (1a), (2a), (3a), (4a) (5a), (6a), (7a), (8a) as shown in the first row of the DCT block 134 shown in FIG. 4A are then temporarily stored in the transpose memory (or “TM” in short as seen in FIG. 9A) 140 during clock cycles 58. During clock cycle 5, the non-zero DCT data (1b) in the second row of the DCT block 106 shown in FIG. 3A are inputted to the first circuit 130. The corresponding first IDCT temporary data (1b), (2b), (3b), (4b) (5b), (6b), (7b), (8b) as shown in the second row of the DCT block 134 shown in FIG. 4A are then temporarily stored in the transpose memory 140 during clock cycles 9˜12. During clock time 9, the non-zero DCT data (2c) in the third row of the DCT block 106 shown in FIG. 3A are inputted to the first circuit 130. The corresponding first IDCT temporary data (1c), (2c), (3c), (4c) (5c), (6c), (7c), (8c) as shown in the third row of the DCT block 134 shown in FIG. 4A are then temporarily stored in the transpose memory 140 during clock cycles 13˜16. During clock time 13, the non-zero DCT data (1e) in the fifth row of the DCT block 106 shown in FIG. 3A are inputted to the first circuit 130. The corresponding first IDCT temporary data (1e), (2e), (3e), (4e) (5e), (6e), (7e), (8e) as shown in the fifth row of the DCT block 134 shown in FIG. 4A are then temporarily stored in the transpose memory 140 during clock cycles 17˜20. During the aforementioned calculation or operation, the zero DCT data 102 in the DCT block 106 can be avoid accessing because the zero information 168 and non-zero information 166 associated with the DCT data 110 in the DCT block 106 are recorded in the first tag table 162, and are referenced during the first 1-D IDCT procedure. In this way, it takes 20 clock cycles to finish the first 1-D IDCT procedure in this example.

FIG. 9B shows the clock cycle and the related operation during the second 1-D IDCT procedure according to the present invention. As shown by referencing FIG. 9B, FIG. 4A and FIG. 2, for example during clock cycle 21, the first IDCT temporary data (1a), (2a) on the same row in FIG. 4A are read out from the transpose memory (or “TM” in short as seen in FIG. 9B) 140, and are individually directed to the first circuit 130 via data line 142 and the second circuit 150 for performing the second 1-D IDCT procedure. Similar operations are done on all the non-zero first IDCT temporary data 136 temporarily stored in the transpose memory 140 during the rest clock cycles 22˜36. In prior art IDCT implementation, the same 2-D IDCT inputs must take at least 64 clock cycles to finish all the IDCT procedure. However, according to the present invention, an efficient architecture for the transpose memory and the data-writing and/or data-reading sequence are utilized. Only 36 clock cycles are required to finish all the same data calculation for the IDCT procedure in this example.

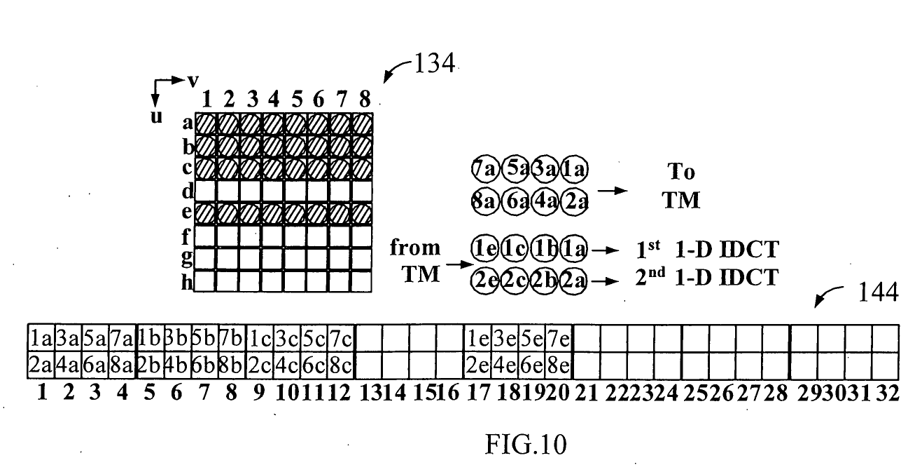

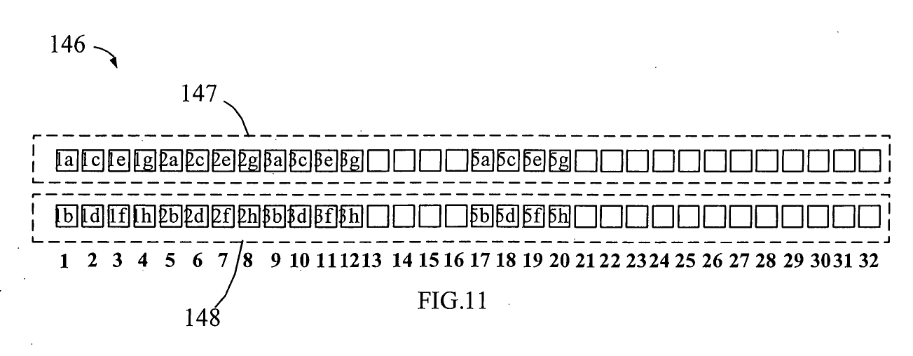

FIG. 10 shows the diagram of a single-bank, single-port, two words/entry transpose memory. In FIG. 10, the physical memory of the transpose memory (or “TM” in short as seen in FIG. 10) 144 is merely single-bank, single-port. That means, due to its “single-port” character, the transpose memory 144 allows either reading data therefrom or writing data thereto, but not both, at a particular time. There are two words/data stored in every entry of the transpose memory 144. When the 2-D IDCT procedure is done by first performing row-wise 1-D IDCT procedure and then performing column-wise 1-D IDCT procedure, the sequence for data-writing into the transpose memory is a row by row sequence and the sequence for data-reading from the transpose memory is a column by column sequence. That is, the data-writing sequence is as follows: (1a, 2a), (3a, 4a), (5a, 6a), (7a, 8a), (1b, 2b), (3b, 4b), (5b, 6b), (7b, 8b) . . . The data-reading sequence is as follows: (1a, 2a), (1b, 2b), (1c, 2c), (1e, 2e), (3a, 4a), (3b, 4b), (3c, 4c), (3e, 4e), (5a, 6a), . . . Either data-reading operation or data-writing operation is performed, but not both, at a particular time. Furthermore, when the data-writing operation is performed, half of the first IDCT temporary data 132 are directed to the first circuit 130 and half of the first IDCT temporary data 132 are directed to the second IDCT circuit 150. In this way, the second 1-D IDCT procedure for further processing the first IDCT temporary data 132 can be concurrently performed in the first circuit 130 and the second IDCT circuit 150.

It is worthwhile noting that the first IDCT temporary data (1e, 2e), (3e, 4e), (5e, 6e), (7e, 8e) can also be stored in the physical address 13, 14, 15, 16. By using the tag table, their original positions in the data block 134 can be correctly found out. Moreover, the data-writing sequence and/or the data-reading sequence allow some variations. For example, the usual data-writing sequence is as follows: (1a, 2a), (3a, 4a), (5a, 6a), (7a, 8a). However, it can be changed as: (1a, 2a), (5a, 6a), (3a, 4a), (7a, 8a) or (1a, 2a), (7a, 8a), (5a, 6a), (3a, 4a). Even the order inside the bracket can be changed as: (1a, 8a), (2a, 7a), (3a, 6a), (4a, 5a).

The most important feature can be characterized in that: if each entry in a single bank memory allows N data to be stored therein, then these N data have to belong to the same row when the first 1-D IDCT procedure is row-wise. Similarly, these N data have to belong to the same column when the first 1-D IDCT procedure is column-wise. When N=1, traditional methods can be employed to offer an implementation solution. Here in this invention, the case when N=2˜M is the focus. M represents the block size. For example, if an 8×8 DCT block is dealt with, then M=8. Though the present invention takes N=2 as an illustration example, it can be equally applied to the case when N=2˜M.

FIG. 11 shows the diagram of a multi-bank, single-port, one word/entry transpose memory. In FIG. 11, the physical memory of the transpose memory 146 is multi-bank, single-port. The transpose memory 146 includes, for example, two independent memory banks, i.e., bank 147 and bank 148. Each entry in bank 147 and bank 148 can store one word data. The data stored in the entries of bank 147 and bank 148 can be independent accessed. The aforementioned first IDCT temporary data can be reallocated in the multiple-bank memory. Data-writing sequence and/or the data-reading sequence can be similar inferred from the description associated with FIG. 10.

The advantages or benefits associated with the present invention can be briefly summarized here. The present invention can reduce the data processing time of the first IDCT circuit 130 and/or the second IDCT circuit 150. For example, the first tag table 162 is employed to assist the blocking of the zero DCT data from entering the first IDCT circuit 130. As can be seen from the FIG. 3A, there are only few non-zero DCT data 104, but a lot of zero DCT data 102 in the incoming DCT block 106. By blocking the zero DCT data from entering the first IDCT circuit 130, the IDCT computation amount needed in the first IDCT circuit 130 is largely reduced. For example, the second tag table 192 is employed and referenced, so that the second IDCT circuit only needs to read out the non-zero first IDCT temporary data, rather than all the first IDCT temporary data stored the transpose memory. In this way, the access time of the transpose memory is largely reduced because only non-zero first IDCT temporary data need to be written in and read out. Other proposals are suggested to achieve the goal of further expediting the IDCT data processing, thus shortening the data processing time. For example, more than one second IDCT circuits could be employed to couple to the transpose memory for sharing the data processing load. For example the second IDCT circuit can be an N-pixel 1-D IDCT circuit or an N-digit 1-D IDCT circuit in order to process more data in a given time period. The transpose memory 140 can also be better designed to assist the load balance between the first IDCT circuit 130 and the second IDCT circuit 150. The aforementioned suggestions are believed to achieve the goal of shortening the processing time in the first IDCT circuit 130 and/or the second IDCT circuit 150 either individually or in combination.

With the examples and explanations above, the features and spirits of the invention will be hopefully well described. Those persons skilled in the art will readily observe that numerous modifications and alterations of the device may be made while retaining the teaching of the invention. Accordingly, the above disclosure should be construed as limited only by the metes and bounds of the appended claims.

1. A data processing apparatus for performing inverse discrete cosine transform (IDCT) procedure on incoming data, comprising:
a first IDCT circuit, for performing a first 1-D IDCT procedure on the incoming data and generating corresponding first IDCT temporary data;
a transpose memory, for temporarily storing the first IDCT temporary data;
a second IDCT circuit, for performing a second 1-D IDCT procedure on the first IDCT temporary data from the transpose memory; and
a controller, for controlling the IDCT procedures in the first and the second IDCT circuits and data access to the transpose memory;
wherein the first IDCT temporary data are directed both to the first and the second IDCT circuits for concurrently performing the second 1-D IDCT procedure.

2. The apparatus according to claim 1, wherein the data processing apparatus is coupled to an inverse quantization circuit, and the incoming data are inverse-quantized DCT data generated by the inverse quantization circuit.

3. The apparatus according to claim 2, wherein the inverse-quantized DCT data are characterized into at least two distinct categories: zero and non-zero data, and the data processing apparatus further comprises a tag table for keeping records of corresponding category information associated with the data.

4. The apparatus according to claim 3, wherein the inverse-quantized DCT data are arranged in corresponding DCT blocks having a plurality of rows and columns, the tag table has a plurality of entries, forming corresponding rows and columns, for recording zero and non-zero information of the DCT data, and the number of the entries in the tag table is the same as the number of DCT data in one DCT block, and wherein the zero information of the DCT data is labeled as a first state in a corresponding entry in the tag table, and the non-zero information of the DCT data is labeled as a second state in a corresponding entry in the tag table.

5. The apparatus according to claim 4, wherein the zero information of the DCT data is labeled as one digital bit 0 in the corresponding entry in the tag table, and the non-zero information of the DCT data is labeled as one digital bit 1 in a corresponding entry in the tag table.

6. The apparatus according to claim 4, wherein the zero information of the DCT data is labeled as one digital bit 1 in the corresponding entry in the tag table, and the non-zero information of the DCT data is labeled as one digital bit 0 in a corresponding entry in the tag table.

7. The apparatus according to claim 4, wherein the controller comprises an address generator for issuing a row address signal and a column address signal, and wherein during the first 1IDCT procedure, the row address signal and the column address signal are both issued to the first IDCT circuit, and wherein during the second 1IDCT procedure, only the row address signal is issued to the first IDCT circuit and/or the second IDCT circuit.

8. The apparatus according to claim 7, wherein the transpose memory is a single-port memory which allows either reading data therefrom or writing data thereto, but not both, at a particular time, and after the first IDCT circuit generates the first IDCT temporary data, the first IDCT temporary data are written into corresponding entries in the transpose memory under the control of the address generator.

9. The apparatus according to claim 8, wherein the entries in the transpose memory are only half of the entries in one DCT block, and every entry in the transpose memory stores two first IDCT temporary data, and wherein the two first IDCT temporary data stored in the same entry are read out from the transpose memory and are sent to the first and the second IDCT circuits respectively.

10. The apparatus according to claim 3, wherein the data processing apparatus further comprises a multiplexer coupled to the transpose memory and the first IDCT circuit, and the multiplexer receives inputs from the incoming data of the inverse quantization circuit and the first IDCT temporary data of the transpose memory, and the multiplexer outputs either the incoming data or the first IDCT temporary data to the first IDCT circuit under the controlling of the controller.

11. The apparatus according to claim 10, wherein when the current incoming datum is identified to be a zero DCT datum after the tag table is referenced, the identified-to-be-zero datum is blocked from entering the first IDCT circuit so as to reduce the total amount of calculation in the first IDCT circuit.

12. The apparatus according to claim 1, wherein the data processing apparatus comprises a plurality of second IDCT circuits coupled to the transpose memory.

13. The apparatus according to claim 1, wherein the second IDCT circuit is selected from the group consisting of an N-pixel 1-D IDCT circuit and an N-digit 1-D IDCT circuit.

14. The apparatus according to claim 1, wherein the transpose memory is a multi-bank transpose memory comprising a multiple of memory banks for independent data access.

15. A data processing apparatus for performing inverse discrete cosine transform (IDCT) procedure on a plurality of incoming data with zero and/or non-zero information, the apparatus comprising:
a first IDCT circuit, for performing a first 1-D IDCT procedure on the incoming data and generating corresponding first IDCT temporary data;
a transpose memory, for temporarily storing the first IDCT temporary data;
a second IDCT circuit, for performing a second 1-D IDCT procedure on the first IDCT temporary data from the transpose memory; and
a controller, for controlling the IDCT procedures in the first and the second IDCT circuits and data access to the transpose memory;
at least one tag table, for keeping records of corresponding zero and non-zero information associated with the incoming data;
wherein the controller records the corresponding zero and/or non-zero information in the tag table so as to reduce the data processing time of the first and/or the second IDCT circuit.

16. The apparatus according to claim 15, wherein the data processing apparatus is coupled to an inverse quantization circuit, and the incoming data are inverse-quantized DCT data generated by the inverse quantization circuit.

17. The apparatus according to claim 15, wherein the tag table is generated from a variable length decoder in a prior-stage system and is copied to the data processing apparatus as a first tag table, and wherein after the data processing apparatus receives the incoming data, the incoming data are analyzed by referencing the corresponding zero and/or non-zero information recorded in the first tag table.

18. The apparatus according to claim 17, wherein when the current incoming datum is identified to be a zero DCT datum after the first tag table is referenced, the identified-to-be-zero datum is blocked from entering the first IDCT circuit so as to reduce the total amount and time of calculation in the first IDCT circuit.

19. The apparatus according to claim 17, wherein after the corresponding first IDCT temporary data are generated by the first IDCT circuit, the corresponding zero and/or non-zero information associated with the generated first IDCT temporary data are updated in the first tag table, and wherein according to the first tag table, only the non-zero first IDCT temporary data, instead of all the first IDCT temporary data, are read out from the transpose memory for performing the second 1-D IDCT procedure, so as to reduce access time of the transpose memory.

20. The apparatus according to claim 17, wherein after the corresponding first IDCT temporary data are generated by the first IDCT circuit, the corresponding zero and/or non-zero information associated with the generated first IDCT temporary data are recorded in a second tag table, and wherein according to the second tag table, only the non-zero first IDCT temporary data, instead of all the first IDCT temporary data, are read out from the transpose memory for performing the second 1-D IDCT procedure, so as to reduce access time of the transpose memory.

21. A data processing method for performing inverse discrete cosine transform (IDCT) procedure on incoming data, comprising the following steps of:
performing a first 1-D IDCT procedure on the incoming data and generating corresponding first IDCT temporary data;
temporarily storing the first IDCT temporary data in a transpose memory;
performing a second 1-D IDCT procedure on the first IDCT temporary data from the transpose memory; and
directing the first IDCT temporary data both to the first and the second IDCT circuits for concurrently performing the second 1-D IDCT procedure.

22. The method according to claim 21, wherein the incoming data are inverse-quantized DCT data generated by an inverse quantization circuit.

23. The method according to claim 22, wherein the inverse-quantized DCT data are characterized into at least two distinct categories: zero and non-zero data, and the method further utilizes a tag table for keeping records of corresponding category information associated with the data.

24. The method according to claim 23, wherein the inverse-quantized DCT data are arranged in corresponding DCT blocks having a plurality of rows and columns, the tag table has a plurality of entries, forming corresponding rows and columns, for recording zero and non-zero information of the DCT data, and the number of the entries in the tag table is the same as the number of DCT data in one DCT block, and wherein the zero information of the DCT data is labeled as a first state in a corresponding entry in the tag table, and the non-zero information of the DCT data is labeled as a second state in a corresponding entry in the tag table.

25. The method according to claim 24, wherein the zero information of the DCT data is labeled as one digital bit 0 in the corresponding entry in the tag table, and the non-zero information of the DCT data is labeled as one digital bit 1 in a corresponding entry in the tag table.

26. The method according to claim 24, wherein the zero information of the DCT data is labeled as one digital bit 1 in the corresponding entry in the tag table, and the non-zero information of the DCT data is labeled as one digital bit 0 in a corresponding entry in the tag table.

27. The method according to claim 24, wherein the method further comprises the following steps of:
issuing both a row address signal and a column address signal to the first IDCT circuit during the first 1IDCT procedure; and
issuing only the row address signal to the first IDCT circuit and/or the second IDCT circuit during the second 1IDCT procedure.

28. The method according to claim 27, wherein the transpose memory is a single-port memory which allows either reading data therefrom or writing data thereto, but not both, at a particular time, and after the first IDCT circuit generates the first IDCT temporary data, the first IDCT temporary data are written into corresponding entries in the transpose memory under the control of the row address signal from the address generator.

29. The method according to claim 28, wherein the entries in the transpose memory are only half of the entries in one DCT block, and every entry in the transpose memory stores two first IDCT temporary data, and wherein the two first IDCT temporary data stored in the same entry are read out from the transpose memory and are sent to the first and the second IDCT circuits respectively.

30. The method according to claim 27, wherein the method further utilizes a multiplexer coupled to the transpose memory and the first IDCT circuit, and the multiplexer receives inputs from the incoming data of the inverse quantization circuit and the first IDCT temporary data of the transpose memory, and the multiplexer outputs either the incoming data or the first IDCT temporary data to the first IDCT circuit under the controlling of a controller.

31. The method according to claim 30, wherein when the current incoming datum is identified to be a zero DCT datum after the tag table is referenced, the identified-to-be-zero datum is blocked from entering the first IDCT circuit so as to reduce the total amount of calculation in the first IDCT circuit.

32. The method according to claim 27, wherein the second IDCT circuit is selected from the group consisting of an N-pixel 1-D IDCT circuit and an N-digit 1-D IDCT circuit.

33. The method according to claim 27, wherein the transpose memory is a multi-bank transpose memory comprising a multiple of memory banks for independent data access.

34. The method according to claim 21, wherein the method utilizes a plurality of second IDCT circuits coupled to the transpose memory.

35. A data processing method for performing inverse discrete cosine transform (IDCT) procedure on a plurality of incoming data with zero and/or non-zero information, the method comprising the following steps of:
performing a first 1-D IDCT procedure on the incoming data and generating corresponding first IDCT temporary data;
temporarily storing the first IDCT temporary data in a transpose memory;
performing a second 1-D IDCT procedure on the first IDCT temporary data from the transpose memory; and
keeping records of corresponding zero and non-zero information associated with the incoming data in at least one tag table;
wherein the corresponding zero and/or non-zero information are recorded in the tag table so as to reduce the data processing time of performing the first and/or the second 1-D IDCT procedures.

36. The method according to claim 35, wherein the incoming data are inverse-quantized DCT data generated by an inverse quantization circuit.

37. The method according to claim 35, wherein the tag table is generated from a variable length decoder in a prior-stage system and is copied to the data processing apparatus as a first tag table, and wherein after the incoming data are received, the incoming data are analyzed by referencing the corresponding zero and/or non-zero information recorded in the first tag table

38. The method according to claim 37, wherein when the current incoming datum is identified to be a zero DCT datum after the first tag table is referenced, the identified-to-be-zero datum is blocked from performing the first 1-D IDCT procedure so as to reduce the total amount and time of calculation in the first 1-D IDCT procedure.

39. The method according to claim 37, wherein after the corresponding first IDCT temporary data are generated, the corresponding zero and/or non-zero information associated with the generated first IDCT temporary data are updated in the first tag table, and wherein according to the first tag table, only the non-zero first IDCT temporary data, rather than all the first IDCT temporary data, are read out from the transpose memory for performing the second 1-D IDCT procedure, so as to reduce access time of the transpose memory.

40. The method according to claim 37, wherein after the corresponding first IDCT temporary data are generated, the corresponding zero and/or non-zero information associated with the generated first IDCT temporary data are recorded in a second tag table, and wherein according to the second tag table, only the non-zero first IDCT temporary data, rather than all the first IDCT temporary data, are read out from the transpose memory for performing the second 1-D IDCT procedure, so as to reduce access time of the transpose memory.
